(19) United States
(12) Patent Application Publication
(10) Pub. No.: US 2003/0012969 A1
(43) Pub. Date: Jan. 16, 2003

(54) Soluble membrane strengthened paper products

(76) Inventor: Bert Thomas Clark, West Jordan, UT (US)

Correspondence Address: Lloyd W. Sadler, Parsons Behle & Latimer, Suite 1800, 201 South Main Street, Salt Lake City, UT, 84111, US

(21) Appl. No.: 10/136,947

(22) Filed: Apr. 30, 2002

Related U.S. Application Data
(63) Continuation-in-part of application No. 09/287,488, filed on Apr. 6, 1999.

(51) Int. Cl. G09F 3/00; B65D 65/28

(52) U.S. Cl. 428/514; 428/43; 428/511; 428/906

(57) ABSTRACT

A strengthened paper product is described, which is composed of multiple layers of paper with one or more intervening layers of water soluble polyvinyl alcohol film for providing additional dry strength while maintaining environmentally safe disintegration/dissolution in water at which time the additional strength of the product is reduced. This invention is particularly adapted to use as toilet tissue, although alternative uses such as cleaning, polishing or buffing cloths, tablecloths, napkins and disposable hospital wear are also accommodated.

### CROSS REFERENCE TO RELATED APPLICATIONS

This application is a Continuation-In-Part Application based on U.S. patent application Ser. No. 09/287,488, filed on Apr. 6, 1999 and currently pending and priority is hereby claimed thereto.

### BACKGROUND OF INVENTION

Field of the Invention. This invention relates to paper products. More specifically this invention relates to paper products having a soluble membrane for providing additional strength.

Description of Related Art. A variety of methods of improving the strength qualities of paper products have been proposed. Typically these methods and products have used some or several of the following techniques: multiple layers of paper, printed or pressed paper layers, chemical treatments and the like. Generally, these techniques provide inadequate strength improvement and may serve to create disposal problems.

This is especially true of those with chemical additives. For general background the reader is directed to the following United States Patent documents, each of which is hereby incorporated by reference in its entirety for the material contained therein.

U.S. Pat. No. 3,661,695 describes two sheets of water-soluble film, which are cemented together with a waterproof adhesive, which forms a thin membrane.

U.S. Pat. No. 3,882,090 describes a water-soluble polyamide having ether linkages in the polymer chain.

U.S. Pat. No. 3,892,905 describes cold-water soluble plastic film made from a polymer mixture of polyvinyl alcohol or polyvinyl pyrrolidone and a different polymer.

U.S. Pat. No. 4,119,604 describes a polyvinyl alcohol composition for use in the preparation of water-soluble films.

U.S. Pat. No. 4,155,971 describes a method of making water-soluble films from polyvinyl alcohol composition.

U.S. Pat. No. 4,156,047 describes water-soluble films made from polyvinyl alcohol compositions.

U.S. Pat. No. 4,215,169 describes melt-extrudable cold-water soluble films, which are suitable for use as packaging film in automatic packaging equipment.

U.S. Pat. No. 4,267,145 describes a process for preparing cold water-soluble films from PVA by melt extrusion.

U.S. Pat. No. 4,376,654 describes a method of producing dispersions of aqueous globules in an aqueous medium.

U.S. Pat. No. 4,528,360 describes a water-soluble film or sheet made of a polyoxyalkylene compound.

U.S. Pat. No. 4,544,693 describes cold water-soluble packaging films formed from compositions, are useful for packaging of agricultural chemicals, which are in granule or dust form.

U.S. Pat. No. 4,557,852 and 4,654,395 describe an addition polymer of a water insoluble soft monomer, a water-soluble anionic monomer and, optionally, a water-soluble nonionic monomer and water insoluble hard monomer, which is neutralized to at least about 75%, and formed into a sheet.

U.S. Pat. No. 4,792,326 describes a rapidly disintegrating paper tampon tube that is formed of a series of layers of paper, adhesive sealing means and superabsorbent material.

U.S. Pat. No. 4,806,261 describes a detersive article, which includes a composition in a closed container or packet formed using a readily water dispersible water-soluble cellulose compound.

U.S. Pat. No. 4,832,791 describes a multipurpose sheet material produced by pressing to sheet form in the presence of water a material derived from a plant of the type Beta Vulgaris.

U.S. Pat. No. 4,872,933 describes a method of forming rapidly disintegrating paper tubes.

U.S. Pat. No. 5,047,469 describes a polyvinyl alcohol and process for making polyvinyl alcohol by hydrolysis catalyzed by acids.

U.S. Pat. No. 5,102,950 describes a water-soluble film comprising a modified polyvinyl alcohol containing 2-pyrrolidone rings.

U.S. Pat. No. 5,143,776 describes a dual laminae tissue laminate having the laminae adhesively joined by a water dispersible and preferably water soluble hot melt adhesive.

U.S. Pat. No. 5,272,191 describes cold-water soluble films and film forming compositions with disintegration improved by incorporating into a film forming polymer composition to form a dry blend or aqueous dispersion.

U.S. Pat. No. 5,336,457 describes a method of making compostable polymeric sheets of biodegradable or environmentally degradable polymers.

U.S. Pat. No. 5,416,181 describes a dried film reinforced with coalescable water insoluble polymer particles, which are substantially non-coalesced.

U.S. Pat. No. 5,429,874 describes a water soluble film suitable for packaging caustic chemicals that has an outer layer of water-soluble polymeric material and an inner layer of polymeric material, which is compatible with the contents of a package made from the film.

U.S. Pat. No. 5,472,518 describes a method of disposing of aqueous-alkali disposable articles, which are made from films or non-woven webs or composites of films and webs where the film or non-woven web comprises a hydrolytically degradable polymer and preferably and a water soluble polymer.

U.S. Pat. No. 5,487,947 describes a water-soluble composite film that includes a special film made mainly of water-soluble high molecular compound.

U.S. Pat. No. 5,502,116 describes biodegradable copolymers and plastic articles comprising biodegradable copolymers of 3-hydroxyhexanoate.

U.S. Pat. No. 5,508,101 describes dispersible compositions and articles and method of disposal for such compositions.

U.S. Pat. No. 5,527,544 describes reinforced films made from water-soluble polymers.

U.S. Pat. No. 5,534,178 describes a uniform, microscopic perforated water-soluble film for detersive compositions.

U.S. Pat. No. 5,536,564 describes biodegradable PHA copolymers and plastic articles comprising biodegradable copolymers of 3-hydroxyhexanoate.

U.S. Pat. No. 5,565,509 describes a dried film reinforced with coalescable water insoluble polymer particles, which are substantially noncoalesced.

U.S. Pat. No. 5,567,510 describes dispersible compositions and articles and method of disposal for such compositions and articles, which are made from films or non-woven webs or composites of films and webs where the film or nonwoven web comprises a hydrolytically degradable polymer and preferably also comprises a water soluble polymer.

U.S. Pat. No. 5,602,227 describes biodegradable PHA copolymers comprising at least two randomly repeating monomer units.

U.S. Pat. No. 5,630,972 describes aqueous-alkali disposable articles made from films or non-woven webs or composites of films and webs.

U.S. Pat. No. 5,656,746 describes a temporary wet strength polymer and compositions for paper products, e.g., toilet tissue.

U.S. Pat. No. 5,667,885 describes a dried film reinforced with coalescable water insoluble polymer particles, which are substantially noncoalesced.

U.S. Pat. No. 5,674,578 describes a water soluble/dispersible multilayered film of high interlayer adhesive strength and collection pouches formed therefrom.

U.S. Pat. No. 5,691,015 describes a composite film bag for packaging that comprises a composite film of a water-insoluble film and a water-soluble polyvinyl alcohol film adhered to one another.

U.S. Pat. No. 5,693,406 describes a multi-ply paper product. One or both of the plies may have embossments protruding towards and contacting the other ply.

The plies are adhesively joined, preferably at such embossments. The adhesive is selected from a composition that advantageously provides a minimum wet ply bond strength and a dry ply bond strength, which falls within a particularly desired range.

U.S. Pat. No. 5,763,065 describes water dispersible multi-layer microfibers of at least one layer of hydrolytically degradable polymer and at least one layer of a water-soluble polymer.

U.S. Pat. No. 5,858,554 describes a multi-ply paper product wherein the plies are adhesively jointed together and wherein the adhesive is selected from a composition that advantageously provides a minimum wet ply bond strength and a dry ply bond strength which falls within a particularly desired range.

U.S. Pat. No. 5,902,669 describes disposable paper products that are provided with an indicator means that gives a visually recognizable signal to a user that desirable properties of the disposable paper product are maintained even after the disposable paper product has become wetted with a substantially transparent aqueous liquid.

### SUMMARY OF INVENTION

It is desirable to provide strengthened water-soluble paper products. It is particularly desirable to provide strengthened water-soluble paper products, which are safe for human contact by virtue of having a generally chemically free paper surface. It is also desirable to have a paper surface product that maintains its strength until it comes in physical contact with water. Accordingly, it is desirable to provide a paper product that has a paper layer and a water-soluble film layer adhered to the paper layer. The water-soluble film layer, being adhered to the paper layer provides increased dry strength to the paper layer. However, the water soluble film layer once it comes in contact with liquid water, essentially dissolves, thereby reducing the strength of the paper product as a whole to that of merely the strength of the paper layer alone. In sum, the combination of the adhered water soluble film layer and the paper layer provide a paper product having increased strength and durability so long as the combination is not in physical contact with water. Once in contact, or immersed in water, the disintegration of the water-soluble film layer substantially reduces the strength and durability of the paper product as a whole, thereby easing the disposal of the paper product as a whole once use is completed.

Accordingly, it is the primary object of this invention to provide a strengthened paper product that is water-soluble.

A further object of this invention is to provide a strengthened paper product that maintains its strength while dry.

Another object of this invention is to provide a strengthened paper product that uses a layered paper-synthetic-paper structure.

It is a further object of this invention to provide a disposable paper product that may loose strength less than one minute after becoming saturated with water.

A still further object of this invention is to provide a strengthened paper product that is adapted for use as disposable toilet paper.

Another further object of this invention is to provide a paper product that maintains dry strength until it comes in contact with water at which point the dry strength enhancing water soluble film dissolves leaving a weakened paper product suitable for easy disposal.

It is another object of this invention to provide a paper product that makes use of a water-soluble film layer to provide enhanced dry strength to the paper product as a whole.

It is a further object of this invention to provide a paper product that once the water soluble film comes in physical contact with water it generally dissolves leaving a substantially weakened paper product.

It is a still further object of this invention to provide a paper product that includes a paper layer and a water soluble film layer and which does not require a separate adhesive to adhere the paper layer to the water soluble film layer.

Additional objects, advantages and other novel features of this invention will be set forth in part in the description that follows and in part will become apparent to those of ordinary skill in the art upon examination of the following or may be learned with the practice of the invention. The objects and advantages of this invention may be realized and attained by means of the intrumentalities, materials and combinations particularly pointed out in the appended claims. Still other objects of the present invention will become readily apparent to those skilled in the art from the following description wherein there is shown and described the preferred embodiment of this invention, simply by way of illustration, as one of the best modes of this invention. As it will be realized, this invention is capable of other embodiments, and its several details and specific materials are capable of modification in various aspects without departing from this invention. Accordingly, the drawings and description should be regarded as illustrative in nature and not as restrictive.

To achieve the foregoing and other objects, and in accordance with the purposes of this invention, a structure of layered paper and water-soluble film is provided.

### BRIEF DESCRIPTION OF DRAWINGS

The accompanying drawings incorporated in and forming a part of the specification, illustrate a preferred embodiment of the present invention. Some although not all, alternative embodiments are described in the following description. In the drawings: FIG. 1a is a cross-section of the preferred embodiment of the paper film paper structure in a dry environment.

FIG. 1b is a cross-section of the preferred embodiment of the paper—film —paper structure after coming into physical contact with water.

FIG. 2 is a perspective view of the preferred embodiment of the invention rolled as would be typical for a toilet paper application of this invention.

Reference will now be made in detail to the present preferred embodiment of the invention, an example of which is illustrated in the accompanying drawings.

### DETAILED DESCRIPTION

This invention is a layered paper product strengthened through the addition of a layer of a water-soluble film between the two or more layers of paper. This invention is particularly adapted to use as toilet tissue, although alternative uses including, but not limited to facial tissue, cleaning, polishing or buffing cloths, table cloths, napkins and disposable hospital wear are also contemplated.

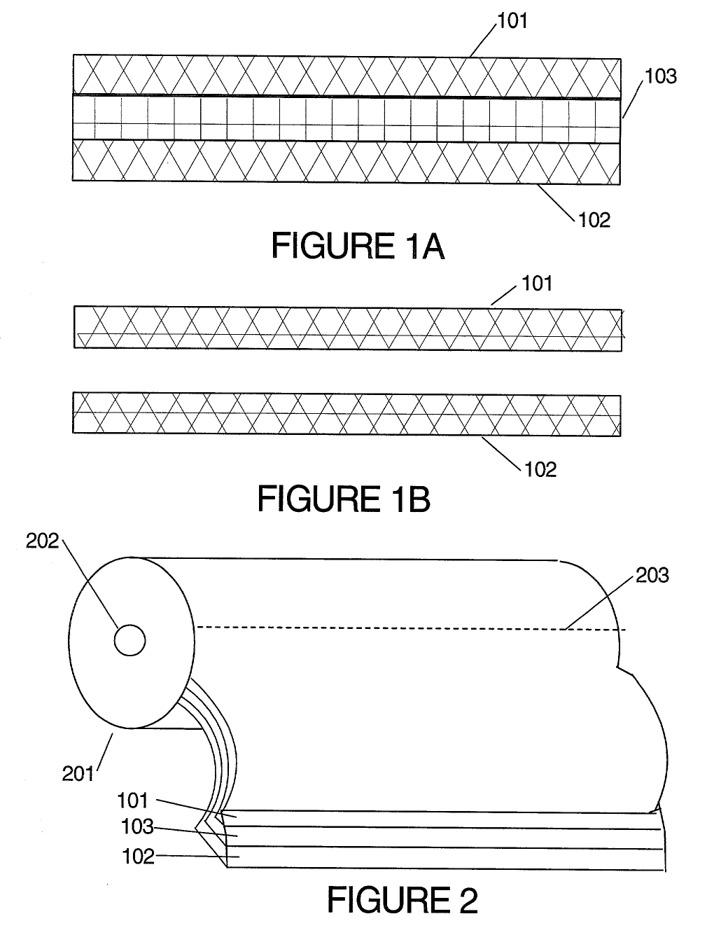

FIG. 1a shows a cross-section view of the preferred embodiment of this invention. A soluble film 103 is provided with a first layer 101 of paper attached to the first side 104 of the film 103, and a second layer 102 of paper attached to the second side 105 of the film 103. Alternative embodiments may continue to alternate film 103 and paper 101 layers, thereby providing a thicker, potentially stronger paper product. In the first preferred embodiment of this invention, that of a toilet paper product, the paper layers 101, 102 are selected from available toilet tissue paper. In the alternative uses, facial tissue, cleaning, polishing or buffing cloths, table cloths, napkins and disposable hospital wear, the paper product is selected appropriate to the use. Preferably, the paper selected will have at least one fairly fibrous side for enhancing the adhesion between the paper 101, 102 and the film 103. The preferred water-soluble film 103 is a polyvinyl alcohol film, such as the Mono Sol® E-6030G film available from Chris Craft Industrial Products, Inc. of Gary, Ind. Alternative films can be substituted without departing from the concept of this invention. Such alternative films include, but are not limited to, Mono Sol® M-9500, Mono Sol® M-7031, and Mono Sol® M-8630. This film is a rapidly dissolving embossed green polyvinyl alcohol film that has good tack characteristics to attaching the film 103 to the paper layers 101, 102 and provides substantial dry strength. This film also has very low toxicity and is regarded as being non-hazardous. Typically, this film disintegrates in 10° C. distilled water in 9 seconds (5 seconds in 24° C. distilled water). Although other alternative films may disintegrate more quickly or more slowly, all of the films used in this invention upon coming into physical contact with water begin to disintegrate from their physically strong film form. Once the film disintegrates it degrades into carbon dioxide and water, thereby providing substantially no further physical strength to the invention as a whole.

This presently preferred film has tensile strength of approximately 4150 psi, a tear resistance of 390 g/mil and an impact strength of 270 grams. Because of the tackiness of the surface of this preferred film 103 the paper layers 101, 102 are held to the film 103 and is thereby strengthened, approximately to the strength of the film 103. In the preferred embodiment of this invention, the film 103 is adhered to the adjacent paper layers 101, 102 by the addition of moisture. Typically, such moisture is added to the film/paper layers either by an increase in ambient humidity, steam, or use of the residual moisture in the paper during the paper making process. Following the moistening adhesion of the film 103 to the paper layers 101, 102, the resulting product is air-dried.

FIG. 1b shows the cross-section of the preferred embodiment of the paper —film—paper structure after coming into physical contact with water. The contact with liquid water has caused the soluble film 103, of FIG. 1a, to disintegrate, leaving the first layer 101 and the second layer 102 of paper separate and without the strengthening support of the soluble film 103. The separate layers 101, 102 of paper are thinner and substantially weaker in their ability to withstand force that was the prior dry paper—film—paper structure, shown in FIG. 1a, of the invention. As such the separate layers 101, 102 are more easily disposed of, through flushing, crushing, burning or other readily known method of waste paper disposal.

FIG. 2 shows the preferred rolled product 201 of this invention. In this embodiment 201 the three layers 101, 102, 103 are rolled around a center paper tube 202. The layers 101, 102, 103 are provided with perforations 203 to facilitate tearing the rolled strengthened paper 201 into separate sheets.

The described embodiments are to be considered in all respects as illustrative and not as restrictive. Although the embodiments shown here have three layers, the invention is not limited thereto. Different numbers of layers, so long as they include a paper layer and a water-soluble film layer should be considered within the scope of this invention. The scope of this invention is indicated by the appended claims rather than by the foregoing description, which is intended to describe the inventor“s best mode of the invention at the time of filing of this application. All changes, which come within the meaning and range of equivalency of the claims, are to be embraced as being within their scope.

1. A strengthened paper product, comprising:
(A) a rollable layer of water soluble film, having a first side and a second side wherein said water soluble film maintains strength of the paper product until said film comes in physical contact with water; and
(B) a first layer of paper attached to said first side of said layer of water soluble film.

2. A strengthened paper product, as recited in claim 1, further comprising:
(C) a second layer of paper attached to said second side of said layer of water-soluble film.

3. A strengthened paper product, as recited in claim 1, wherein said layer of water soluble film is tacky to provide attachment to said first layer of paper.

4. A strengthened paper product, as recited in claim 1, wherein said layer of water-soluble film is a polyvinyl alcohol film.

5. A strengthened paper product, as recited in claim 1, wherein said first layer of paper is toilet tissue.

6. A strengthened paper product, as recited in claim 1, wherein said first layer of paper is facial tissue.

7. A strengthened paper product, as recited in claim 1, wherein said first layer of paper is a disposable napkin.

8. A strengthened paper product, as recited in claim 1, wherein said first layer of paper is used in disposable hospital clothing.

9. A strengthened paper product, as recited in claim 1, wherein said first layer of paper is used in disposable cleaning cloths.

10. A strengthened paper product, as recited in claim 1, wherein said first layer of paper is used in polishing cloths.

11. A strengthened paper product, as recited in claim 1, wherein said first layer of paper is used in buffing cloths.

12. A strengthened paper product, as recited in claim 1, wherein said first layer of paper is used in disposable tablecloths.

13. A strengthened paper products, as recited in claim 1, wherein said layer of paper and said layer of water soluble film are rolled onto a tube forming a rolled paper product.

14. A strengthened paper product, as recited in claim 13, wherein said rolled layer of paper and said rolled layer of water soluble film each have a plurality of perforations for separating said rolled paper product into one or more individual sheets.
